(19) United States
(12) Patent Application Publication
(10) Pub. No.: US 2023/0301303 A1
(43) Pub. Date: Sep. 28, 2023

(54) A STORAGE STABLE INSECTICIDAL COMPOSITION

(71) Applicant: UPL Limited, Mumbai (IN)

(72) Inventors: Ankush Mali, Mumbai (IN); Pravin Namadeo More, Mumbai (IN); Rajan Ramakant Shirsat, Mumbai (IN)

(21) Appl. No.: 18/041,420

(22) PCT Filed: Aug. 14, 2021
(86) PCT No.: PCT/IB2021/057502

§ 371 Date: Feb. 13, 2023

(30) Foreign Application Priority Data
Aug. 14, 2020 (IN) 202021035156

(51) Int. Cl. A01N 53/00; A01N 51/00; A01N 47/34; A01N 25/22; A01N 43/56; A01N 43/40; A01N 47/06; A01N 25/04; A01N 25/28

(52) U.S. Cl. CPC A01N 53/00; A01N 51/00; A01N 47/34; A01N 25/22; A01N 43/56; A01N 43/40; A01N 47/06; A01N 25/04; A01N 25/28

(57) ABSTRACT

The present invention relates to an insecticidal composition comprising lambda-cyhalothrin with other active ingredients. The insecticidal composition of the present invention is storage stable. The present invention also describe process of preparation and methods of use of the same.

### FIELD OF THE INVENTION

The present invention relates to a storage stable insecticidal composition. The present invention more particularly relates to a storage stable insecticidal composition of lambda-cyhalothrin with other active ingredients.

### BACKGROUND AND THE PRIOR ART

The control of pests is important in achieving desired levels of crop efficiency. Pest damage to growing and stored agronomic crops can cause significant reduction in productivity, which can result in increased costs to the consumer. Many products are commercially available and commonly used for controlling pests, some of them are used as single active composition or some are used as combination of more than one active. However, due to acquired resistance over the years, compositions with more than one active are commonly and frequently been used. Such compositions broaden the spectrum of applicability, and delay the development of resistance to pesticides, including insecticides, by combining the application of two or more products.

Pyrethroid compounds have excellent pesticidal activity. Pyrethroid compounds are one of the preferred choices for pest-control. One such pyrethroid, Lambda-cyhalothrin is a synthetic pyrethroid, developed as an insecticide for agricultural applications and it is used to control wide spectrum of insect pests, e. g. aphids, colorado beetles, thrips, lepidoptera larvae, coleoptera larvae, etc. Lambda-cyhalothrin is a broad-spectrum insecticide effective at low rates of application against major insect pests in a wide range of crops, including cotton, soybean, green vegetables, tomato, potato, wheat, barley, maize, sorghum, vines, fruit tree crops, among others.

Cyhalothrin is a mixture of four isomers, and two of these isomers compose lambda-cyhalothrin. Chemically, lambda-cyhalothrin is a 1:1 mixture of S-isomer, (S)-α-cyano-3-phenoxybenzyl-(Z)-(1R,3R)-3-(2-chloro-3,3,3-trifluoroprop-1-enyl)-2,2-dimethylcyclopropane carboxylate and R-isomer, (R)-α-cyano-3-phenoxybenzyl (Z)-(1S,3S)-3-(2-chloro-3,3,3-trifluoroprop-1-enyl)-2,2-dimethylcyclopropane carboxylate. This 1:1 mixture is known to be active and have better insecticidal activity than other two isomers of cyhalothrin. It is known that upon storing lambda-cyhalothrin, these active isomers tend to transform to the inactive isomers of cyhalothrin. Such kind of isomeric transformation lead to less biologically efficacious compositions of lambda-cyhalothrin.

When lambda-cyhalothrin is combined with a second active, the problem of isomeric transformation further exaggerates. Attempts have been made in the prior art to develop compositions of lambda-cyhalothrin either alone or in combination with another active ingredient which are storage stable.

IN259005 discloses lambda-cyhalothrin Emulsifiable Concentrate (EC) composition in which isomer transformation is prevented by addition of phosphate esters selected from alkyl or aryl alkoxylate, alkoxylates of fatty alcohol, alkoxylates of fatty acids, block co-polymers of ethylene oxide and propylene oxide, polyaryl substituted aliphatic or aromatic alkoxylate and alkoxylated polyaryl substituted phenol, their derivatives and mixtures.

3586/DEL/2013 discloses synergistic combination of imidacloprid and lambda-cyhalothrin formulated as soluble liquid (SL) using formulation ingredients such as polyvinyl pyrrolidone copolymer, ethoxylated alkyl aryl phenol emulsifier, dimethyl sulfoxide solvent and N-methyl pyrrolidone. It does not address isomeric transformation related issues while combining lambda-cyhalothrin and imidacloprid.

As a result, there has been an ongoing need to develop stable formulations in a suitable form containing lambda-cyhalothrin combining with another active ingredient which has good shelf life and storage stability.

### Objective of the Invention

An object of the present invention is to provide a storage stable insecticidal composition.

Another object of the present invention is to provide a storage stable insecticidal composition of lambda-cyhalothrin in combination with another insecticide.

Yet another object of the present invention is to provide a storage stable insecticidal composition of lambda-cyhalothrin in combination with another insecticide which does not undergo isomeric transformation even after prolonged storage.

Still another object of the present invention is to provide a process of preparing storage stable insecticidal composition of lambda-cyhalothrin in combination with another insecticide.

### SUMMARY OF THE INVENTION

In an aspect, the present invention provides a storage stable insecticidal composition comprising:
(a) Lambda-cyhalothrin in an amount of 0.1% to 50% by weight of the composition;
(b) at least one insecticide in an amount of 0.1% to 50% by weight of the composition; and
(c) mixture of a weak acid and its salt.

In another aspect, the present invention provides a storage stable insecticidal composition comprising:
(a) Lambda-cyhalothrin in an amount of 0.1% to 50% by weight of the composition;
(b) at least one insecticide selected from group comprising of neonicotinoids and benzoylphenyl urea compounds in an amount of 0.1% to 50% by weight of the composition; and
(c) mixture of weak acid and its salt.

In another aspect, the present invention provides a process for the preparation of storage stable insecticidal composition comprising (a) Lambda-cyhalothrin in an amount of 0.1% to 50% by weight of the composition; (b) at least one insecticide in an amount of 0.1% to 50% by weight of the composition; and (c) mixture of weak acid and its salt; wherein said process comprising steps of:
(a) mixing lambda-cyhalothrin with another insecticide in a suitable system,
(b) optionally, adding other excipients(s) to obtain pre-mix,
(c) adding mixture of weak acid and its salt to the pre-mix to obtain storage stable insecticidal composition.

In yet another aspect, the present invention provides use of storage stable insecticidal composition according to the present invention to control wide range of insects.

In another aspect, the present invention provides a method for controlling pests, which comprises applying effective amounts of storage stable insecticidal composition comprising (a) Lambda-cyhalothrin in an amount of 0.1% to 50% by weight of the composition; (b) at least one insecticide in an amount of 0.1% to 50% by weight of the composition; and (c) mixture of weak acid and its salt, to pests or a locus where the pests inhabit.

In another aspect, the present invention provides a kit. The kit comprises a plurality of components, each of which components may include at least one, or more, of the ingredients of the storage stable insecticidal composition of the present invention.

### DETAILED DESCRIPTION OF THE INVENTION

The inventors of the present invention surprisingly found that addition of the mixture of weak acid and its salts in the composition comprising lambda-cyhalothrin with another active ingredient have an important effect on lambda-cyhalothrin stability. The presence of the mixture of weak acid and its salts found to control isomer transformation by preventing conversion of active isomer to inactive isomer. The compositions and methods disclosed herein thus provide an important tool in solving the lambda-cyhalothrin stability problem associated with isomer transformation.

The term “isomeric transformation” as applied to an insecticidal composition means that lambda-cyhalothrin does not undergo conversion to inactive isomer of lambda-cyhalothrin.

The term “storage stable” as applied to an “insecticidal composition” means that the insecticidal composition does not undergo isomeric transformation from active isomers of lambda-cyhalothrin to inactive isomers of lambda-cyhalothrin for at least two years at ambient temperature and within a range of temperatures, which include extreme temperatures that can be experienced under normal storage conditions, for example a range from 0° C. to 40° C. or preferably a range from −5° C. to 40° C.

Without being bound by theory, it is believed that mixture of weak acid and its salt in the present invention acts to prevent isomeric transformation of lambda-cyhalothrin from active form to the inactive form. Use of mixture of weak acid and its salt in liquid compositions comprising lambda-cyhalothrin imparts the physicochemical stability to the product.

The present invention relates to a storage stable insecticidal composition comprising lambda-cyhalothrin in combination with another insecticide.

According to an embodiment of the present invention, there is provided an insecticidal composition comprising:
a) Lambda-cyhalothrin in an amount of 0.1% to 50% by weight of the composition;
b) at least another insecticide in an amount of 0.1% to 50% by weight of the composition; and
c) a mixture of a weak acid and its salt.

According to an embodiment of the present invention, a storage stable insecticidal composition comprises:
(a) Lambda-cyhalothrin in an amount of 0.1% to 50% by weight of the composition;
(b) at least one another insecticide in an amount of 0.1% to 50% by weight of the composition; and
(c) mixture of weak acid and its salt.

According to an embodiment of the present invention, a storage stable insecticidal composition comprises of Lambda-cyhalothrin.

According to an embodiment of the present invention, said another insecticide is selected from the group consisting of Acetylcholinesterase (AChE) inhibitors, GABA-gated chloride channel blockers, Sodium channel modulators, Nicotinic acetylcholine receptor (nAChR) competitive modulators, Nicotinic acetylcholine receptor (nAChR) allosteric modulators—Site I, Glutamate-gated chloride channel (GluCl) allosteric modulators, Juvenile hormone mimics, Miscellaneous nonspecific (multi-site) inhibitors, Chordotonal organ TRPV channel modulators, Mite growth inhibitors affecting CHS1, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Inhibitors of chitin biosynthesis affecting CHS1, Inhibitors of chitin biosynthesis type 1, Moulting disruptors Dipteran, Ecdysone receptor agonists, Octopamine receptor agonists, Mitochondrial complex III electron transport inhibitors, Mitochondrial complex I electron transport inhibitors, Voltage-dependent sodium channel blockers, Inhibitors of acetyl CoA carboxylase, Mitochondrial complex IV electron transport inhibitors, Mitochondrial complex II electron transport inhibitors, Ryanodine receptor modulators, Chordotonal organ Modulators—undefined target site, GABA-gated chloride channel allosteric modulators, Baculoviruses, Nicotinic Acetylcholine Receptor (nAChR) Allosteric Modulators—Site II, Compounds of unknown or uncertain MoA, Bacterial agents (nonBt) of unknown or uncertain MoA, Botanical essence including synthetic, extracts and unrefined oils with unknown or uncertain MoA, Non-specific mechanical disruptors and combinations thereof.

In an embodiment, said another insecticide is selected from: Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, Xylylcarb, Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, Vamidothion, Chlordane, Endosulfan, Ethiprole, Fipronil, Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambdaCyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin, DDT, Methoxychlor, Acetamiprid, Clothianidin, Dinotefuran, Imidacloprid, Nitenpyram, Thiacloprid, Thiamethoxam, Nicotine, Sulfoxaflor, Flupyradifurone, Triflumezopyrim, Spinetoram, Spinosad, Abamectin, Emamectin benzoate, Lepimectin, Milbemectin, Hydroprene, Kinoprene, Methoprene, Fenoxycarb, Pyriproxyfen, Methyl bromide and other alkyl halides, Chloropicrin, Cryolite (Sodium aluminum fluoride), Sulfuryl fluoride, Borax, Boric acid, Disodium octaborate, Sodium borate, Sodium metaborate, Tartar emetic, Dazomet, Metam, Pymetrozine, Pyrifluquinazon, Afidopyropen, Clofentezine, Diflovidazin, Hexythiazox, Etoxazole, Diafenthiuron, Azocyclotin, Cyhexatin, Fenbutatin oxide, Propargite, Tetradifon, Chlorfenapyr, DNOC, Sulfluramid, Bensultap, Cartap hydrochloride, Thiocyclam, Thiosultap-sodium, Bistrifluron, Chlorfluazuron, Diflubenzuron, Flucycloxuron, Flufenoxuron, Hexaflumuron, Lufenuron, Novaluron, Noviflumuron, Teflubenzuron, Triflumuron, Buprofezin, Cyromazine, Chromafenozide, Halofenozide, Methoxyfenozide, Tebufenozide, Amitraz, Hydramethylnon, Acequinocyl, Fluacrypyrim, Bifenazate, Fenazaquin, Fenpyroximate, Pyridaben, Pyrimidifen, Tebufenpyrad, Tolfenpyrad, Rotenone (Derris), Indoxacarb, Metaflumizone, Spirodiclofen, Spiromesifen, Spiropidion, Spirotetramat, Aluminium phosphide, Calcium phosphide, Phosphine, Zinc phosphide, Calcium cyanide, Potassium cyanide, Sodium cyanide, Cyenopyrafen, Cyflumetofen, Pyflubumide, Chlorantraniliprole, Cyantraniliprole, Cyclaniliprole Flubendiamide, Tetraniliprole, Flonicamid, Broflanilide, Fluxametamide, Cydia pomonella GV, Thaumatotibia leucotreta GV, Anticarsia gemmatalis MNPV, Helicoverpa armigera NPV, GS-omega/kappa HXTX-Hv1a peptide, Azadirachtin, Benzoximate, Bromopropylate, Chinomethionat, Dicofol, Lime sulfur, Mancozeb, Pyridalyl, Sulfur, Burkholderia spp, Wolbachia pipientis (Zap), Chenopodium ambrosioides near ambrosioides extract, Fatty acid monoesters with glycerol or propanediol Neem oil, Beauveria bassiana strains, Metarhizium anisopliae strain F52, Paecilomyces fumosoroseus Apopka strain 97, Diatomaceous earth.

According to an embodiment of the present invention, said another insecticide is selected from the group consisting of neonicotinoids, benzoylphenyl urea, tetramic acid, diamide insecticide, flonicamid and combinations thereof.

According to an embodiment of the present invention, neonicotinoid insecticide is selected from the group consisting of clothianidin, imidacloprid, acetamiprid, thiamethoxam and thiacloprid.

According to preferred embodiment of the present invention neonicotinoid insecticide is imidacloprid.

According to preferred embodiment of the present invention neonicotinoid insecticide is acetamiprid.

According to preferred embodiment of the present invention neonicotinoid insecticide is clothianidin.

According to an embodiment of the present invention, benzoylphenyl urea insecticide is selected from the group consisting of bistrifluron, chlorbenzuron, chlorfluazuron, dichlorbenzuron, diflubenzuron, flucycloxuron, flufenoxuron, hexaflumuron, lufenuron, novaluron, noviflumuron, penfluron, teflubenzuron and triflumuron.

According to preferred embodiment of the present invention benzoylphenyl urea insecticide is novaluron.

According to preferred embodiment of the present invention benzoylphenyl urea insecticide is lufenuron.

According to preferred embodiment of the present invention benzoylphenyl urea insecticide is chlorfluazuron.

According to an embodiment of the present invention, the tetramic acid insecticide is spirotetramat.

According to an embodiment of the present invention, the diamide insecticide is selected from the group consisting of chlorantraniliprole, cyantraniliprole, cyclaniliprole, tetrachlorantraniliprole and tetraniliprole.

According to a preferred embodiment, the diamide insecticide is chlorantraniliprole.

According to a preferred embodiment, the diamide insecticide is cyantraniliprole.

According to a preferred embodiment, the diamide insecticide is cyclaniliprole.

According to a preferred embodiment, the diamide insecticide is tetraniliprole.

According to an embodiment, said another insecticide is imidacloprid, novaluron, spirotetramat, flonicamid or chlorantraniliprole.

According to an embodiment of the present invention, a storage stable insecticidal composition comprises of lambda-cyhalothrin from about 0.1% w/w to about 50% w/w; and preferably, from about 0.5% to about 40% lambda-cyhalothrin of the total weight of the storage stable insecticidal composition.

In a preferred embodiment of the present invention, a storage stable insecticidal composition comprises of lambda-cyhalothrin from about 1% w/w to about 30% w/w of the total weight of the storage stable insecticidal composition.

According to an embodiment of the present invention, the storage stable insecticidal composition comprises of at least one more insecticide.

The said one more insecticide is selected from a group consisting of Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, Xylylcarb, Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, Vamidothion, Chlordane, Endosulfan, Ethiprole, Fipronil, Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambdaCyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin, DDT, Methoxychlor, Acetamiprid, Clothianidin, Dinotefuran, Imidacloprid, Nitenpyram, Thiacloprid, Thiamethoxam, Nicotine, Sulfoxaflor, Flupyradifurone, Triflumezopyrim, Spinetoram, Spinosad, Abamectin, Emamectin benzoate, Lepimectin, Milbemectin, Hydroprene, Kinoprene, Methoprene, Fenoxycarb, Pyriproxyfen, Methyl bromide and other alkyl halides, Chloropicrin, Cryolite (Sodium aluminum fluoride), Sulfuryl fluoride, Borax, Boric acid, Disodium octaborate, Sodium borate, Sodium metaborate, Tartar emetic, Dazomet, Metam, Pymetrozine, Pyrifluquinazon, Afidopyropen, Clofentezine, Diflovidazin, Hexythiazox, Etoxazole, Diafenthiuron, Azocyclotin, Cyhexatin, Fenbutatin oxide, Propargite, Tetradifon, Chlorfenapyr, DNOC, Sulfluramid, Bensultap, Cartap hydrochloride, Thiocyclam, Thiosultap-sodium, Bistrifluron, Chlorfluazuron, Diflubenzuron, Flucycloxuron, Flufenoxuron, Hexaflumuron, Lufenuron, Novaluron, Noviflumuron, Teflubenzuron, Triflumuron, Buprofezin, Cyromazine, Chromafenozide, Halofenozide, Methoxyfenozide, Tebufenozide, Amitraz, Hydramethylnon, Acequinocyl, Fluacrypyrim, Bifenazate, Fenazaquin, Fenpyroximate, Pyridaben, Pyrimidifen, Tebufenpyrad, Tolfenpyrad, Rotenone (Derris), Indoxacarb, Metaflumizone, Spirodiclofen, Spiromesifen, Spiropidion, Spirotetramat, Aluminium phosphide, Calcium phosphide, Phosphine, Zinc phosphide, Calcium cyanide, Potassium cyanide, Sodium cyanide, Cyenopyrafen, Cyflumetofen, Pyflubumide, Chlorantraniliprole, Cyantraniliprole, Cyclaniliprole Flubendiamide, Tetraniliprole, Flonicamid, Broflanilide, Fluxametamide, Cydia pomonella GV, Thaumatotibia leucotreta GV, Anticarsia gemmatalis MNPV, Helicoverpa armigera NPV, GS-omega/kappa HXTX-Hv1a peptide, Azadirachtin, Benzoximate, Bromopropylate, Chinomethionat, Dicofol, Lime sulfur, Mancozeb, Pyridalyl, Sulfur, Burkholderia spp, Wolbachia pipientis (Zap), Chenopodium ambrosioides near ambrosioides extract, Fatty acid monoesters with glycerol or propanediol Neem oil, Beauveria bassiana strains, Metarhizium anisopliae strain F52, Paecilomyces fumosoroseus Apopka strain 97 and Diatomaceous earth.

According to an embodiment of the present invention, the said storage stable insecticidal composition comprises of at least one more insecticide selected from the group comprising of organophosphate, pyrethroids, benzoylphenyl urea, neonicotinoids and the like.

According to an embodiment of the present invention, one more insecticide of the storage stable insecticidal composition is flonicamid.

According to an embodiment of the present invention, one more insecticide of the storage stable insecticidal composition is spirotetramat.

According to an embodiment of the present invention, one more insecticide of the storage stable insecticidal composition is spirodiclofen.

According to an embodiment of the present invention, one more insecticide of the storage stable insecticidal composition is bifenthrin.

According to an embodiment of the present invention, one more insecticide of the storage stable insecticidal composition is chlorantraniliprole.

According to an embodiment of the present invention, the storage stable insecticidal composition comprises insecticide from about 0.1% w/w to about 50% w/w; and preferably from about 0.5% w/w to about 40% w/w insecticide by weight of the storage stable insecticidal composition.

According to preferred embodiment of the present invention, the storage stable insecticidal composition comprises insecticide from about 1% w/w to about 30% w/w by weight of the storage stable insecticidal composition.

According to an embodiment of the present invention, a storage stable insecticidal composition comprises of a mixture of weak acid and its salt.

According to an embodiment of the present invention, a storage stable insecticidal composition comprises of a mixture of weak organic acid and its salt or a mixture of weak inorganic acid and its salt According to an embodiment of the present invention, the storage stable insecticidal composition comprises of the mixture of weak organic acid and its salts.

According to an embodiment of the present invention, the weak organic acids are selected are selected from the group comprising of citric acid, acetic acid, succinic acid, tartaric acid, oxalic acid and the like.

According to an embodiment of the present invention, the storage stable insecticidal composition comprises of citric acid and its salts selected from the group comprising of sodium citrate, sodium citrate monobasic, sodium citrate dibasic, potassium citrate and the like.

According to an embodiment of the present invention, the storage stable insecticidal composition comprises of acetic acid and its salts selected from the group comprising of sodium acetate, ammonium acetate and the like.

According to an embodiment of the present invention, the storage stable insecticidal composition comprises of succinic acid and its salts selected from sodium succinate mono and dibasic.

According to an embodiment of the present invention, the storage stable insecticidal composition comprises of tartaric acid and its salts selected from sodium tartarate monobasic and sodium tartarate dibasic.

According to an embodiment of the present invention, the salts of weak organic acids may be added or may be generated in-situ by adding mixture of weak acid and a base.

According to an embodiment of the present invention, the storage stable insecticidal composition comprises of the mixture of weak inorganic acid and its salts.

According to an embodiment of the present invention, the weak inorganic acids are selected are selected from the group comprising of phosphoric acid, nitrous acid, sulphurous acid, hydrofluoric acid and the like.

According to an embodiment of the present invention, the storage stable insecticidal composition comprises of phosphoric acid and its salts selected from the group comprising of sodium phosphate dibasic, sodium phosphate monobasic, potassium metaphosphate, potassium phosphate dibasic, potassium phosphate monobasic, ammonium phosphate, diluted potassium metaphosphate.

According to an embodiment of the present invention, the storage stable insecticidal composition comprising mixture of a weak acid (organic and inorganic) and its salt is selected from the group comprising of citric acid and its salts; acetic acid and its salts; boric acid and its salts; succinic acid and its salts; glutaric acid and its salts; maleic acid and its salts; tartaric acid and its salts; oxalic acid and its salts; and phosphoric acid and its salts.

According to preferred embodiment of the present invention, the storage stable insecticidal composition comprising mixture of a weak acid and its salt is selected from the group comprising of citric acid monohydrate and trisodium citrate dihydrate; tripotassium phosphate and phosphoric acid; tri sodium citrate and citric acid; sodium dihydrogen phosphate dihydrate and phosphoric acid and monobasic dihydrogen phosphate and dibasic monohydrogen phosphate.

According to an embodiment of the present invention, a storage stable insecticidal composition comprises mixture of weak acid and its salt from about 0.1% to about 20% of the by weight of the storage stable insecticidal composition.

According to preferred embodiment of the present invention, a storage stable insecticidal composition comprises mixture of weak acid and its salt from about 0.1% to about 10% of the by weight of the storage stable insecticidal composition.

According to an embodiment of the present invention, the mixture of weak acid and its salts are in the storage stable composition is combined in a ratio to achieve pH ranging from 4 to 5.5.

In another aspect, the present invention provides an insecticidal composition comprising:
(a) Lambda-cyhalothrin in an amount of 0.1% to 50% by weight of the composition;
(b) at least one insecticide selected from group consisting of neonicotinoids, benzoylphenyl urea, tetramic acid, diamide insecticide and flonicamid in an amount of 0.1% to 50% by weight of the composition; and
(c) mixture of weak acid and its salt.

In another aspect, the present invention provides a storage stable insecticidal composition comprising:
(d) Lambda-cyhalothrin in an amount of 0.1% to 50% by weight of the composition;
(e) at least one insecticide selected from group consisting of neonicotinoids, benzoylphenyl urea, tetramic acid, diamide insecticide and flonicamid compounds in an amount of 0.1% to 50% by weight of the composition; and
(f) mixture of weak acid and its salt.

According to an embodiment of the present invention, the said storage stable insecticidal composition comprises of at least one insecticide selected from the classes consisting of neonicotinoids, benzoylphenyl urea, tetramic acid, diamide insecticide and flonicamid.

According to an embodiment of the present invention, neonicotinoid insecticide is selected from the group comprising of clothianidin, imidacloprid, acetamiprid, thiamethoxam and thiacloprid.

According to preferred embodiment of the present invention neonicotinoid insecticide is imidacloprid.

According to preferred embodiment of the present invention neonicotinoid insecticide is acetamiprid.

According to preferred embodiment of the present invention neonicotinoid insecticide is clothianidin.

According to an embodiment of the present invention, benzoylphenyl urea insecticide is selected from the group comprising of istrifluron, chlorbenzuron, chlorfluazuron, dichlorbenzuron, diflubenzuron, flucycloxuron, flufenoxuron, hexaflumuron, lufenuron, novaluron, noviflumuron, penfluron, teflubenzuron and triflumuron.

According to preferred embodiment of the present invention benzoylphenyl urea insecticide is novaluron.

According to preferred embodiment of the present invention benzoylphenyl urea insecticide is lufenuron.

According to preferred embodiment of the present invention benzoylphenyl urea insecticide is chlorfluazuron.

According to an embodiment of the present invention, the tetramic acid insecticide is spirotetramat.

According to an embodiment of the present invention, the diamide insecticide is selected from the group consisting of chlorantraniliprole, cyantraniliprole, cyclaniliprole, tetrachlorantraniliprole and tetraniliprole.

According to a preferred embodiment, the diamide insecticide is chlorantraniliprole.

According to a preferred embodiment, the diamide insecticide is cyantraniliprole.

According to a preferred embodiment, the diamide insecticide is cyclaniliprole.

According to a preferred embodiment, the diamide insecticide is tetraniliprole.

According to an embodiment of the present invention, the ratio of active lambda-cyhalothrin to inactive lambda-cyhalothrin in the storage stable insecticidal composition is about 80:20.

According to an embodiment of the present invention, the ratio of active lambda-cyhalothrin to inactive lambda-cyhalothrin in the storage stable insecticidal composition is about 90:10.

According to an embodiment of the present invention, the ratio of active lambda-cyhalothrin to inactive lambda-cyhalothrin in the storage stable insecticidal composition is about 95:5.

According to an embodiment of the present invention, the ratio of active lambda-cyhalothrin to inactive lambda-cyhalothrin in the storage stable insecticidal composition is about 99:1.

According to an embodiment of the present invention, the active isomer content of lambda-cyhalothrin in the storage stable insecticidal composition is not less than 85%±10.

According to an embodiment of the present invention, the active isomer content of lambda-cyhalothrin in the storage stable insecticidal composition is not less than 95%.

According to an embodiment of the present invention, the active isomer content of lambda-cyhalothrin in the storage stable insecticidal composition is not less than 98%.

According to an embodiment of the present invention the insecticide in the stable insecticidal composition is selected from the group comprising of imidacloprid, acetamiprid, flonicamid, clothianidin, acephate, bifenthrin, fipronil, lufenuron, novaluron, diafenthiuron, spirotetramat and chlorantraniliprole.

In an embodiment of the present invention, the storage stable insecticidal composition may further comprises one or more antifreeze agent, thickening agents, wetting agents, fillers, surfactants, preservatives, antifoaming agents, colorants and other formulation aids.

Suitable antifreeze agents that can be added to the storage stable insecticidal composition are aqueous polyols, for example ethylene glycol, propylene glycol or glycerol.

Suitable thickening agents include xanthan gum, attagel 50, bentonite, silica and the like.

Suitable wetting agents that can be added to the storage stable insecticidal composition include, but are not limited to: polyarylalkoxylated phosphate esters and their potassium salts (e.g., Soprophor® FLK, Stepfac TSP PE-K. Other suitable wetting agents include Block copolymer of polyalkylene oxide, sodium dioctylsulfosuccinates (e.g., Geropon® SDS, Aerosol® OT) and ethoxylated alcohols (e.g., Trideth-6; Rhodasurf® BC 610; Tersperse® 4894), Poly(oxy-1,2-ethanediyl) and Silwet 408.

Suitable fillers may include all substances which can normally be used for this purpose in insecticidal compositions and which do not act as thickeners. Examples of suitable inert fillers include inorganic particles, such as carbonates, silicates and oxides, and also organic substances, such as urea/formaldehyde condensates. By way of more particular example, kaolin, rutile, silica, finely divided silica, silica gels, and natural and synthetic silicates, and also talc may be mentioned. Mixtures of inorganic and organic fillers, and of different specific fillers within each class may be used.

Suitable anionic surfactants include polyacrylates, alkylbezenesulfonates (Example: TERWET 1004) such as dodecylbenzenesulfonates, for example calcium dodecylbenzensulfonate, ethoxylated and/or propoxylated di- or tri-styrylphenol phosphates, ethoxylated and/or propoxylated di- or tri-styrylphenol sulfates, phenyl sulfonates, lignosulphonates, alkynaphtalenesulphonates, ethoxylated and/or propoxylated alcohol phosphate esters, ethoxylated and/or propoxylated alkylaryl phosphate esters, taurates, sulphosuccinates, and polycarboxylates, Sodium alkylnaphthalene sulfonate formalin condensate or modified styrene-maleic anhydride copolymer). Examples of the commercially available alkyl naphthalene sulfonate sodium formalin condensate include Morwet D425, TERSPERSE 2020, Agrosurf WG-2300 and the like.

Suitable non-ionic surfactants include alkoxylated surfactants and block copolymer surfactants. Examples of useful alkoxylated surfactants for the invention include castor oil ethoxylate, tridecyl alcohol ethoxylate, nonyl phenol ethoxylate, octyl phenol ethoxylate, tristryl phenol ethoxylate, phosphate ester ethoxylate, tallow amine ethoxylate, cocoa amine ethoxylate, and oleyl amine ethoxylate.

Suitable preservatives used may be benzisothiazolinone (Proxel GXL) or phenols, 2-bromo-2-nitropropane-1,3-diol (Bioban BP 30), 5-chloro-2-methyl-4-isothiazolin-3-one & 2 methyl-4-isothiazolin-3 one (Kathon CG/ICP), Glutaraldehyde (Ucarcide 50), Chloromethylisothiazolinone (CMIT)/Methylisothiazolinone (MIT) (Isocil Ultra 1.5), 2.2-dibromo-3-nitrilopropioamide (Reputain 20), Natamycin & Nisin, Bronopol/CMIT/MIT (Mergal 721K3).

Suitable antifoaming agents or defoamers are employed to stop any unwanted foam generated while manufacturing suspension concentrate composition of the present application. The preferred antifoaming agent is selected from the group consisting of silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Preferable defoamers include AGNIQUE DFM 1115; SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770.

Suitable colorants (for example in red, blue and green) are, preferably, pigments, which are sparingly soluble in water, and dyes, which are water-soluble. Examples are inorganic coloring agents (for example iron oxide, titanium oxide, and iron hexacyanoferrate) and organic coloring agents (for example alizarin, azo and phthalocyanin coloring agents).

In an embodiment of the present invention, an insecticidal composition comprises lambda-cyhalothrin from about 0.1% w/w to about 50% w/w, at least one another insecticide from about 0.1% w/w to about 50% w/w and mixture of weak acid and its salt from 0.1% w/w to 20% w/w of the total weight of the storage stable insecticidal composition.

In an embodiment of the present invention, the storage stable insecticidal composition comprises lambda-cyhalothrin from about 0.1% w/w to about 50% w/w, at least one another insecticide from about 0.1% w/w to about 50% w/w and mixture of weak acid and its salt from 0.1% w/w to 20% w/w of the total weight of the storage stable insecticidal composition.

In an embodiment of the present invention, an insecticidal composition comprises lambda-cyhalothrin from about 0.5% w/w to about 30% w/w, at least one another insecticide from about 0.5% w/w to about 30% and mixture of weak acid and its salt from and 0.5% w/w to 20% w/w mixture of the total weight of the storage stable insecticidal composition.

In an embodiment of the present invention, the storage stable insecticidal composition comprises lambda-cyhalothrin from about 0.5% w/w to about 30% w/w, at least one another insecticide from about 0.5% w/w to about 30% and mixture of weak acid and its salt from and 0.5% w/w to 20% w/w mixture of the total weight of the storage stable insecticidal composition.

In an embodiment of the present invention, an insecticidal composition comprises lambda-cyhalothrin from about 0.1% w/w to about 50% w/w, imidacloprid from about 0.1% w/w to about 50% w/w and mixture of weak acid and its salt from 0.1% w/w to 20% w/w of the total weight of the storage stable insecticidal composition.

In an embodiment of the present invention, an insecticidal composition comprises lambda-cyhalothrin from about 0.1% w/w to about 50% w/w, novaluron from about 0.1% w/w to about 50% w/w and mixture of weak acid and its salt from 0.1% w/w to 20% w/w of the total weight of the storage stable insecticidal composition.

In an embodiment of the present invention, an insecticidal composition comprises lambda-cyhalothrin from about 0.1% w/w to about 50% w/w, spirotetramat from about 0.1% w/w to about 50% w/w and mixture of weak acid and its salt from 0.1% w/w to 20% w/w of the total weight of the storage stable insecticidal composition.

In an embodiment of the present invention, an insecticidal composition comprises lambda-cyhalothrin from about 0.1% w/w to about 50% w/w, chlorantraniliprole from about 0.1% w/w to about 50% w/w and mixture of weak acid and its salt from 0.1% w/w to 20% w/w of the total weight of the storage stable insecticidal composition.

In an embodiment of the present invention, an insecticidal composition comprises lambda-cyhalothrin from about 0.1% w/w to about 50% w/w, flonicamid from about 0.1% w/w to about 50% w/w and mixture of weak acid and its salt from 0.1% w/w to 20% w/w of the total weight of the storage stable insecticidal composition.

In an embodiment of the present invention, an insecticidal composition comprises lambda-cyhalothrin from about 0.5% w/w to about 30% w/w, imidacloprid from about 0.5% w/w to about 30% w/w and mixture of citric acid monohydrate and trisodium citrate dihydrate from 0.5% w/w to 20% w/w of the total weight of the storage stable insecticidal composition.

In an embodiment of the present invention, an insecticidal composition comprises lambda-cyhalothrin from about 0.5% w/w to about 30% w/w, novaluron from about 0.5% w/w to about 30% w/w and mixture of phosphoric acid and potassium hydrogen phosphate from 0.5% w/w to 20% w/w of the total weight of the storage stable insecticidal composition.

In an embodiment of the present invention, an insecticidal composition comprises lambda-cyhalothrin from about 0.5% w/w to about 30% w/w, spirotetramat from about 0.5% w/w to about 30% w/w and mixture of citric acid monohydrate and trisodium citrate dihydrate from 0.5% w/w to 20% w/w of the total weight of the storage stable insecticidal composition.

In an embodiment of the present invention, an insecticidal composition comprises lambda-cyhalothrin from about 0.5% w/w to about 30% w/w, chlorantraniliprole from about 0.5% w/w to about 30% w/w and mixture of citric acid monohydrate and trisodium citrate dihydrate from 0.5% w/w to 20% w/w of the total weight of the storage stable insecticidal composition.

In an embodiment of the present invention, an insecticidal composition comprises lambda-cyhalothrin from about 0.5% w/w to about 30% w/w, flonicamid from about 0.5% w/w to about 30% w/w and mixture of citric acid monohydrate and trisodium citrate dihydrate from 0.5% w/w to 20% w/w of the total weight of the storage stable insecticidal composition.

In an embodiment of the present invention, the storage stable insecticidal composition is formulated in the form of liquid composition.

In an embodiment of the present invention, the storage stable insecticidal composition is formulated as suspension concentrate (SC), a mixed formulation of CS and SC (ZC), soluble liquid (SL), emulsion-in-water (EW), formulation for seeds (FS).

According to an embodiment of the present invention, in the storage stable insecticidal composition comprising lambda-cyhalothrin in combination with another insecticide, lambda-cyhalothrin is in the form of particulate when formulated as SC and in dissolved form when formulated as emulsion; and in both as capsulated or absorbed particle with solvent.

According to preferred embodiment of the present invention, the storage stable insecticidal composition is formulated as suspension concentrate (SC).

According to an embodiment of the present invention, lambda-cyhalothrin and an insecticide are suspended in the aqueous environment in the SC composition.

In an embodiment of the present invention, an insecticidal composition comprising lambda-cyhalothrin from about 0.1% w/w to about 50% w/w, at least one another insecticide from about 0.1% w/w to about 50% w/w and mixture of weak acid and its salt 0.1% w/w to 20% w/w of the total weight of the storage stable insecticidal composition, wherein the said composition is in the form of suspension concentrate (SC).

In an embodiment of the present invention, an insecticidal composition comprises lambda-cyhalothrin from about 0.5% w/w to about 30% w/w, novaluron from about 0.5% w/w to about 30% w/w and mixture of phosphoric acid and potassium hydrogen phosphate from 0.5% w/w to 20% w/w of the total weight of the storage stable insecticidal composition, wherein the said composition is in the form of suspension concentrate (SC).

In an embodiment of the present invention, an insecticidal composition comprises lambda-cyhalothrin from about 0.5% w/w to about 30% w/w, spirotetramat from about 0.5% w/w to about 30% w/w and mixture of citric acid monohydrate and trisodium citrate dihydrate from 0.5% w/w to 20% w/w of the total weight of the storage stable insecticidal composition, wherein the said composition is in the form of suspension concentrate (SC).

In an embodiment of the present invention, an insecticidal composition comprises lambda-cyhalothrin from about 0.5% w/w to about 30% w/w, chlorantraniliprole from about 0.5% w/w to about 30% w/w and mixture of citric acid monohydrate and trisodium citrate dihydrate from 0.5% w/w to 20% w/w of the total weight of the storage stable insecticidal composition, wherein the said composition is in the form of suspension concentrate (SC).

In an embodiment of the present invention, an insecticidal composition comprises lambda-cyhalothrin from about 0.5% w/w to about 30% w/w, flonicamid from about 0.5% w/w to about 30% w/w and mixture of citric acid monohydrate and trisodium citrate dihydrate from 0.5% w/w to 20% w/w of the total weight of the storage stable insecticidal composition, wherein the said composition is in the form of suspension concentrate (SC).

In an embodiment of the present invention, an insecticidal composition comprising lambda-cyhalothrin from about 0.5% w/w to about 30% w/w, imidacloprid from about 0.5% w/w to about 30% w/w and mixture of citric acid monohydrate and trisodium citrate dihydrate from 0.5% w/w to 20% w/w of the total weight of the storage stable insecticidal composition wherein said composition is in the form of suspension concentrate (SC).

According to preferred embodiment of the present invention, the storage stable insecticidal composition is formulated as a mixed formulation of Capsule suspension (CS) and Suspension concentrate (SC) in which one insecticide is directly suspended in aqueous medium and another insecticide is encapsulated and suspended in the same aqueous medium; such formulation is known as ZC formulation.

According to preferred embodiment of the present invention, the ZC formulation composition comprises (i) microencapsulated lambda-cyhalothrin suspended in water, characterised in that the microcapsules are made of polymeric material; and (ii) another insecticide suspended in water.

According to some embodiments of the present invention, polymeric material of the microcapsules encapsulating lambda-cyhalothrin is selected from polyurea and polyurethane.

According to some embodiments of the present invention, storage stable insecticidal composition comprises of microcapsules having polyurea wall encapsulating lambda-cyhalothrin wherein the polyurea wall of the microcapsule is from a mixture of polymethylene polyphenylisocyanate and an isomeric mixture of dicyclohexylmethane-4,4′diisocyanate.

In an embodiment of the present invention, an insecticidal composition comprises lambda-cyhalothrin from about 0.1% w/w to about 50% w/w, at least one another insecticide from about 0.1% w/w to about 50% w/w and mixture of weak acid and its salt from 0.1% w/w to 20% w/w of the total weight of the storage stable insecticidal composition wherein said composition is in the form of ZC formulation.

In an embodiment of the present invention, an insecticidal composition comprising from about lambda-cyhalothrin 0.5% w/w to about 30% w/w, novaluron from about 0.5% w/w to about 30% w/w and mixture of phosphoric acid and potassium hydrogen phosphate from 0.5% w/w to 20% w/w of the total weight of the storage stable insecticidal composition, wherein the said composition is in the form of ZC formulation.

In an embodiment of the present invention, an insecticidal composition comprises lambda-cyhalothrin from about 0.5% w/w to about 30% w/w, spirotetramat from about 0.5% w/w to about 30% w/w and mixture of citric acid monohydrate and trisodium citrate dihydrate from 0.5% w/w to 20% w/w of the total weight of the storage stable insecticidal composition, wherein the said composition is in the form of ZC formulation.

In an embodiment of the present invention, an insecticidal composition comprises lambda-cyhalothrin from about 0.5% w/w to about 30% w/w, chlorantraniliprole from about 0.5% w/w to about 30% w/w and mixture of citric acid monohydrate and trisodium citrate dihydrate from 0.5% w/w to 20% w/w of the total weight of the storage stable insecticidal composition, wherein the said composition is in the form of ZC formulation.

In an embodiment of the present invention, an insecticidal composition comprises lambda-cyhalothrin from about 0.5% w/w to about 30% w/w, flonicamid from about 0.5% w/w to about 30% w/w and mixture of citric acid monohydrate and trisodium citrate dihydrate from 0.5% w/w to 20% w/w of the total weight of the storage stable insecticidal composition, wherein the said composition is in the form of ZC formulation.

In an embodiment of the present invention, an insecticidal composition comprising lambda-cyhalothrin from about 0.5% w/w to about 30% w/w, imidacloprid from about 0.5% w/w to about 30% w/w and mixture of citric acid monohydrate and trisodium citrate dihydrate from 0.5% w/w to 20% w/w of the total weight of the storage stable insecticidal composition, wherein the said composition is in the form of ZC formulation.

According to an embodiment of the present invention, a process for preparation of an insecticidal composition comprising (a) Lambda-cyhalothrin in an amount of 0.1% to 50% by weight of the composition; (b) at least one another insecticide in an amount of 0.1% to 50% by weight of the composition; and (c) a mixture of a weak acid and its salt; wherein said process comprising steps of:
(a) mixing lambda-cyhalothrin with another insecticide in a suitable system,
(b) optionally, adding other excipients(s) to obtain pre-mix,
(c) adding mixture of a weak acid and its salt to the pre-mix to obtain storage stable insecticidal composition.

According to an embodiment of the present invention, a process for the preparation of storage stable insecticidal composition comprising (a) Lambda-cyhalothrin in an amount of 0.1% to 50% by weight of the composition; (b) at least one another insecticide in an amount of 0.1% to 50% by weight of the composition; and (c) a mixture of a weak acid and its salt; wherein said process comprising steps of:
(a) mixing lambda-cyhalothrin with another insecticide in a suitable system,
(b) optionally, adding other excipients(s) to obtain pre-mix,
(c) adding mixture of a weak acid and its salt to the pre-mix to obtain storage stable insecticidal composition.

According to an embodiment of the present invention, a process for the preparation of an insecticidal composition comprising (a) Lambda-cyhalothrin in an amount of 0.1% to 50% by weight of the composition; (b) at least one another insecticide in an amount of 0.1% to 50% by weight of the composition; and (c) mixture of a weak acid and its salt; wherein said process comprising steps of:
i. mixing lambda-cyhalothrin and other insecticide in an aqueous condition and adding other excipients(s) to obtain pre-mix,
ii. milling the resulting pre-mix;
iii. adding thickener and mixture of a weak acid and its salts to the pre-mix followed by homogenization to obtain storage stable insecticidal composition in the form of suspension concentrate.

According to an embodiment of the present invention, a process for the preparation of an insecticidal composition comprising (a) Lambda-cyhalothrin in an amount of 0.1% to 50% by weight of the composition; (b) at least one another insecticide in an amount of 0.1% to 50% by weight of the composition; and (c) a mixture of a weak acid and its salt; wherein said process comprising steps of:
i. mixing lambda-cyhalothrin and other insecticide in an aqueous condition and optionally, adding other excipients(s) to obtain pre-mix,
ii. milling the resulting pre-mix;
iii. adding mixture of a weak acid and its salts to the pre-mix; and
iv. gellifying the mixture by separately prepared thickener composition to obtain storage stable insecticidal composition in the form of suspension concentrate.

1. According to an embodiment of the present invention, A process for the preparation of a composition comprising (a) Lambda-cyhalothrin in an amount of 0.1% to 50% by weight of the composition; (b) at least another insecticide in an amount of 0.1% to 50% by weight of the composition; and (c) a mixture of a weak acid and its salt; wherein said process comprises:
i. preparing a capsule suspension of lambda-cyhalothrin;
ii. preparing a suspension concentrate of another insecticide;
iii. separately dissolving an amine salt in water to obtain an amine solution;
iv. mixing the suspension concentrate of step (ii), a mixture of a weak acid and its salt, the amine solution and the capsule suspension of lambda-cyhalothrin to obtain a ZC composition.

According to an embodiment of the present invention, a process for the preparation of an insecticidal composition comprising (a) Lambda-cyhalothrin in an amount of 0.1% to 50% by weight of the composition; (b) at least one another insecticide in an amount of 0.1% to 50% by weight of the composition; and (c) a mixture of a weak acid and its salt; wherein said process comprises:
i. preparing an organic phase comprising lambda-cyhalothrin solubilized in vegetable oil or derivatives thereof, and at least one isocyanate;
ii. preparing an aqueous phase by mixing suitable auxiliary ingredients in water;
iii. separately dissolving an amine salt in water to obtain an amine solution;
iv. mixing the organic phase of step (i), the aqueous phase of step (ii) and the amine solution of step (iii) to obtain an encapsulated lambda-cyhalothrin as capsule suspension;
v. separately preparing a suspension concentrate of another insecticide;
vi. mixing the capsule suspension of step (iv) with the suspension concentrate of step (v);
vii. adding the mixture of weak acid and its salt to obtain the composition in the form of a ZC formulation.

In an embodiment, the storage stable insecticidal composition of the invention has a particle size distribution D₁₀ of less than about 10 microns.

In an embodiment, the storage stable insecticidal composition of the invention has a particle size distribution D₁₀ of less than about 5 microns.

In an embodiment, the storage stable insecticidal composition of the invention has a particle size distribution D₅₀ of less than about 10.0 microns.

In an embodiment, the storage stable insecticidal composition of the invention has a particle size distribution D₅₀ of less than about 5 microns.

In an embodiment, the storage stable insecticidal composition of the invention has a particle size distribution D₅₀ of less than about 2 microns.

In an embodiment, the storage stable insecticidal composition of the invention has a particle size distribution D₉₀ of less than or equal to about 20 microns.

In an embodiment, the storage stable insecticidal composition of the invention has a particle size distribution D₉₀ of less than or equal to about 15 microns.

In an embodiment, the storage stable insecticidal composition of the invention has a particle size distribution D₉₀ of less than or equal to about 10 microns.

According to an embodiment of the present invention, the storage stable insecticidal composition prepared in above steps for obtaining suspension concentrate composition is subjected to particle size reduction by applying shear to the mixture of lambda-cyhalothrin, insecticide and mixture of weak acid and its salt and other auxiliary agents. Suitable devices for this purpose are the devices that offers milling operation e.g. high shear mixers like ROS HSM, Ultra-Turrax apparatus, and dissolvers, static mixers, e.g. systems having mixing nozzles, bead mills, vibratory mills, agitator bead mills, colloid mills, cone mills, circulating mills (agitator ball mills with pin grinding system), disk mills, annular chamber mills, double cone mills, sprocket dispersers or homogenizers and other homogenizers.

According to an embodiment of the present invention, the storage stable insecticidal composition is designed to be diluted with water (or a water-based aqueous) to form the corresponding end-use agrochemical formulations, typically spray formulations.

According to an embodiment of the present invention, the storage stable insecticidal composition requires a formulation which allows the active compounds to be taken up by the pests and insects.

According to an embodiment of the present invention, the storage stable insecticidal composition is used as the source of active agrochemical ingredients and will typically be diluted to form end-use formulations, typically spray formulations. The dilution may be with water at from 1 to 10,000, particularly 10 to 1,000, times the total weight of the storage stable insecticidal composition to form the spray formulation. Said storage stable insecticidal composition may be diluted for use having an agrochemical active concentration of about 0.5 wt % to about 1 wt. %. In said diluted composition the agrochemical active concentration may be in the range from about 0.001 wt. % to about 1 wt. % of the total formulation as sprayed.

Spray formulations include all the components which it is desired to apply to the plants or their environment. Spray formulations can be made up by simple dilution of aqueous insecticidal composition containing agrochemically active ingredients, or by mixing of the individual agrochemically active ingredients, or a combination of diluting the storage stable insecticidal composition and adding further individual agrochemically active ingredients or mixtures of agrochemically active ingredients. Typically, such end use mixing is carried out in the tank from which the formulation is sprayed, or alternatively in a holding tank for filling the spray tank. Such mixing and mixtures are typically termed tank mixing and tank mixtures.

According to an embodiment of the present invention, the storage stable insecticidal composition is used to control wide range of insects.

In an embodiment of the present invention, the storage stable insecticidal composition controls pests and insects listed below;

Insects from the order of the Lepidoptera, for example Agrotisypsilon, Chilo infuscatellus, Chilo partellus, Chilo suppressalis, Cnaphalocrocis medinalis, Cydia pomonella, Earias vittella, Earias insulana, Helicoverpa armigera, Leucinodes orbonalis, Maruca testulalis, Mythimna separata, Pectinophora gossypiella, Phyllocnistis citrella, Pieris bras-sicae, Plutella xylostella, Scirpophaga incertulas, Sesamia inferens, Spodoptera frugiperda, Spodoptera littoralis, Spodoptera litura, Tryporyza novella, Tuta absoluta and Zeiraphera Canadensis. Beetles (Coleoptera), for example Diabrotica longicornis, Diabrotica semipunctata, Diabrotica punctata, Diabrotica speciosa, Diabrotica virgifera, Dicladispa armigera, Epila-chna varivestis, Holotrichia bicolor, Holotrichia consanguinea, Leptinotarsa decemlineata, flies (Diptera), e.g. Atherigona orientalis, Dacus cucurbi-tae, Liriomyza trifolii, Melanagromyza obtuse, thrips (Thysanoptera), e.g. Frankliniella occidentalis, Frankliniella tritici, Scirtothrips citri, Scirtothrips dorsalis, Thrips oryzae, Thrips palmi and Thrips tabaci, termites (Isoptera), e.g. Calotermes flavicollis, Coptotermes formosanus, Heterotermes aureus, Leucotermes flavipes, Microtermes obesi, Odontotermes obesus, Reticulitermes flavipes, Termes natalensis. true bugs (Hemiptera), e.g. Amrasca biguttula biguttula, Amrasca devastans, Amritodus atkinsoni, Aphis gossypii, Aphis crassivora, Bemisia argentifolii, Bemisia tabaci, Dysdercus cingulatus, Empoasca fabae, Idioscopus spp. My-zus persicae, Nilaparvata lugens, Nephotettix virescens, Nephotettix nigropictus, Planococcus spp., Pseudococcus spp., Pyrilla perpusilla, Sogatella furcifera, Trialeurodes vaporariorum, Toxoptera aurantiia, Psylla spp., Rhopalosiphum spp., Sitobion spp.

According to an embodiment of the present invention, the storage stable insecticidal composition can be applied to any and all developmental stages of pests, such as egg, larva, pupa, and adult. The pests may be controlled by contacting the target pest, its food supply, habitat, breeding ground or its locus with an effective amount of said composition of the present invention.

According to an embodiment of the present invention, the storage stable insecticidal compositions comprising various mixtures are highly effective in controlling insect pests, in GMO (Genetically Modified Organism) and Non GMO varieties of Cotton (Gossypium spp.), Paddy (Oryza sativa), Wheat (Triticum aestavum), Maize (Zea mays), Sugarcane (Saccharum officinarum), Sugarbeet (Beta vulgaris), Soybean (Glycin max), Peanut (Arachis hypogaea), Green gram (Vigna radiata), Black gram (Vigna mungo), Chickpea (Cicer aritinum), Redgram (Cajanus cajan), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanum lycopersicun), Potato (Solanum tuberosum), Chilly (Capsicum annum), Garlic (Allium sativum), Cucumber (Cucumis sativus), Muskmelons (Cucumis melo), Watermelon (Citrullus lanatus), Bottle gourd (Lagenaria siceraria), Apple (Melus domestica), Banana (Musa spp.), Citrus groups (Citrus spp.), Grape (Vitis vinifera), Guava (Psidium guajava), Litchi (Litchi chinensis), Mango (Mangifera indica), Papaya (Carica papaya), Pineapple (Ananas comosus), Pomegranate (Punica granatum), Tea (Camellia sinensis), Coffea (Coffea Arabica), Turmeric (Curcuma longa), Ginger (Zingiber officinale), Cumin (Cuminum cyminum).

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) at least one another insecticide in an amount of 0.1% to 50% by weight of the composition; and (c) a mixture of a weak acid and its salt, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) imidacloprid in an amount of 0.1% to 50% by weight of the composition; and (c) a mixture of a weak acid and its salt, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) imidacloprid in an amount of 0.1% to 50% by weight of the composition; and (c) and 0.5% w/w to 20% w/w mixture of citric acid monohydrate and trisodium citrate dihydrate, to pests or a locus where the pests inhabit.

According to an embodiment of the present invention, there is provided a method for controlling pests, which comprises applying effective amounts of storage stable insecticidal composition comprising (a) Lambda-cyhalothrin in an amount of 0.1% to 50% by weight of the composition; (b) novaluron in an amount of 0.1% to 50% by weight of the composition; and (c) a mixture of a weak acid and its salt, to pests or a locus where the pests inhabit.

According to an embodiment of the present invention, a method for controlling pests, which comprises applying effective amounts of storage stable insecticidal composition comprising (a) Lambda-cyhalothrin in an amount of 0.1% to 50% by weight of the composition; (b) novaluron in an amount of 0.1% to 50% by weight of the composition; and (c) 0.5% w/w to 20% w/w mixture of phosphoric acid and potassium hydrogen phosphate, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) spirotetramat in an amount of 0.1% to 50% by weight of the composition; and (c) a mixture of a weak acid and its salt, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) spirotetramat in an amount of 0.1% to 50% by weight of the composition; and (c) and 0.5% w/w to 20% w/w mixture of citric acid monohydrate and trisodium citrate dihydrate, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) flonicamid in an amount of 0.1% to 50% by weight of the composition; and (c) a mixture of a weak acid and its salt, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) flonicamid in an amount of 0.1% to 50% by weight of the composition; and (c) and 0.5% w/w to 20% w/w mixture of citric acid monohydrate and trisodium citrate dihydrate, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) chlorantraniliprole in an amount of 0.1% to 50% by weight of the composition; and (c) a mixture of a weak acid and its salt, to pests or a locus where the pests inhabit.

According to an embodiment of the present invention, there is provided a method for controlling pests, which comprises applying effective amounts of an insecticidal composition comprising (a) Lambda-cyhalothrin in an amount of 0.1% to 50% by weight of the composition; (b) chlorantraniliprole in an amount of 0.1% to 50% by weight of the composition; and (c) and 0.5% w/w to 20% w/w mixture of citric acid monohydrate and trisodium citrate dihydrate, to pests or a locus where the pests inhabit According to an embodiment of the present invention, a kit is provided. The kit comprises of a plurality of components, each of which components may include at least one, or more, of the ingredients of the storage stable insecticidal composition of the present invention.

In accordance with the above objectives, the present invention provides a kit comprising:
(a) a first component comprising Lambda-cyhalothrin;
(b) a second component comprising another insecticide; and
(c) a third component comprising a mixture of a weak acid and its salt,
wherein the first, second and third components are instructed to be admixed before being applied to a locus.

According to an embodiment of the present invention, the various components of the storage stable insecticidal composition can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare storage stable insecticidal composition. E. g., kits may include active ingredients and/or mixture of weak acid and its salt One or more of the components may already be combined together or pre-formulated. In those embodiments where more than two components are provided in a kit, the components may already be combined together and as such are packaged in a single container such as a vial, bottle, can, pouch, bag or canister.

In other embodiments, two or more components of a kit may be packaged separately, i. e., not pre-formulated. As such, kits may include one or more separate containers such as vials, cans, bottles, pouches, bags or canisters, each container containing a separate component for storage stable insecticidal composition.

In both forms, a component of the kit may be applied separately from or together with the further components or as a component of a combination composition according to the invention for preparing the storage stable insecticidal composition according to the invention.

In a preferred embodiment of the present invention, an insecticidal composition comprising (a) Lambda-cyhalothrin in an amount of 0.1% to 50% by weight of the composition; (b) at least one another insecticide in an amount of 0.1% to 50% by weight of the composition; and (c) a mixture of a weak acid and its salt is in the form of a kit with single pack or multi pack.

All the features described herein may be combined with any of the above aspects, in any combination.

In order that the present invention may be more readily understood, reference will now be made, by way of example, to the following description. It will be understood that all tests and physical properties listed have been determined at atmospheric pressure and room temperature (i.e. 25° C.), unless otherwise stated herein, or unless otherwise stated in the referenced test methods and procedures. It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### Example-1 Lambda-cyhalothrin 50 g/L+Imidacloprid 125 g/L SC

| Ingredients | Quantity (w/w) |
|---|---|
| Imidacloprid | 240 |
| Lambda-cyhalothrin | 97.4 |
| 1,2,3-Propanetriol | 100 |
| Amine salt of polyarylphenyl ether phosphate | 60 |
| Clay | 30 |
| Silicone antifoam | 16 |
| Xanthan gum | 160 |
| 1,2-Benzisothiazolin-3-One Solution | 5 |
| Block copolymer of Propylene Oxide and Ethylene Oxide | 30 |
| Citric acid monohydrate | 12 |
| Trisodium citrate dihydrate | 28 |
| Water | 1221.6 |
| Total | 2000.00 |

100 g 1,2,3-Propanetriol, 60 g Amine salt of polyarylphenyl ether phosphate, 30 g block copolymer of propylene oxide and ethylene oxide were charged in a mixing vessel and homogenized using Remi table top homogenizer. 16 g silicone antifoam, and about 610 g water was added under continued homogenization. 240 g imidacloprid and 97.4 g lambda-cyhalothrin was also added to the same homogenizing vessel. This homogenized mixture was the taken to bead mill for particle size reduction to obtain slurry. To the ground slurry, separately, prepared solution obtained by dissolving 12 g citric acid monohydrate and 28 g trisodium citrate dihydrate was added. Finally, remaining quantity of water and 160 g xanthan gum containing 5 g 1,2-Benzisothiazolin was added to obtain suspension concentrate composition.

### Example-2 Lambda-cyhalothrin 50 g/L+Imidacloprid 125 g/L SC (Comparative Example)

| Ingredients | Quantity (w/w) |
|---|---|
| Imidacloprid | 240 |
| Lambda-cyhalothrin | 97.4 |
| 1,2,3-Propanetriol | 100 |
| Amine salt of polyarylphenyl ether phosphate | 60 |
| Clay | 30 |
| Silicone antifoam | 16 |
| Xanthan gum | 160 |
| 1,2-Benzisothiazolin-3-One Solution | 5 |
| Block copolymer of propylene oxide and ethylene oxide | 30 |
| Water | 1221.6 |
| Total | 2000.00 |

100 g 1,2,3-Propanetriol, 60 g Amine salt of polyarylphenyl ether phosphate, 30 g block copolymer of propylene oxide and ethylene oxide were charged in a mixing vessel and homogenized using Remi table top homogenizer. 16 g silicone antifoam, and about 610 g water was added under continued homogenization. 240 g imidacloprid and 97.4 g lambda-cyhalothrin were also added to the same homogenizing vessel. This homogenized mixture was the taken to bead mill for particle size reduction to obtain slurry. Finally, remaining quantity of water and 160 g xanthan gum containing 5 g 1,2-Benzisothiazolin was added to obtain suspension concentrate composition.

### Example-3 Lambda-cyhalothrin 20 g/L and Novaluron 100 g/L ZC

| | |
|---|---|
| Ingredients | Quantity (% w/w) |

Lambda-cyhalothrin 23-24% Conc CS

| | |
|---|---|
| Lambda-cyhalothrin | 24.74 |
| Soyabean oil | 17 |
| An oligomeric isocyanate, poly[methylene(phenylene | 0.02 |
| isocyanate)](PMPI) | |
| Hexamethylene diisocyanate (HMDI) | 0.61 |
| Water | 40.29 |
| Sodium lignosulfonate | 5 |
| Silicone antifoam | 0.1 |
| Ethylene diamine | 0.33 |
| Propylene Glycol | 6 |
| Block copolymer surfactant | 2.5 |
| Hydrochloric acid | 1.31 |
| Xanthan gum | 2 |
| 1,2-Benzisothiazolin-3-One Solution | 0.1 |
| Total | 100 |

Novaluron Mill base

| | |
|---|---|
| Novaluron | 52.61 |
| Sodium lignosulfonate | 3.00 |
| Block copolymer of propylene oxide and ethylene | 1.50 |
| oxide | |
| Propylene glycol | 6.00 |
| Water | 36.39 |
| Silicone antifoam | 0.50 |
| Total | 100.00 |

Novaluron 100 g/L + Lambda-cyhalothrin 20 g/L ZC

| | |
|---|---|
| Novaluron mill base | 193.2 |
| Lambda-cyhalothrin CS | 89.4 |
| Water | 516 |
| Xanthan gum (2% gel) | 88.5 |
| Propylene Glycol | 83.00 |
| Trisiloxane ethoxylate | 15 |
| Clay | 8.5 |
| 1,2-Benzisothiazolin-3-One Solution | 1.4 |
| Silicone antifoam | 5.0 |
| Tripotassium Phosphate | 12.19 |
| Phosphoric acid | 2.81 |
| Total | 1015.00 |

Preparation of Lambda-cyhalothrin CS:
Preparation of organic phase: 24.74 g Lambda-cyhalothrin technical, 17 g soyabean oil, 0.02 g PMPI and 0.61 HMDI was mixed and homogenized to obtain organic phase.
Preparation of aqueous phase: 5 g sodium lignosulphonate, 6 g propylene glycol, 2.5 g block copolymer surfactant, 0.1 g silicone antifoam and 40.29 g water were mixed and homogenized to obtain aqueous phase.
Preparation of ethylene diamine: 0.33 g ethylene diamine was dissolved in water to obtain solution.

Previously prepared organic phase was added to previously prepared aqueous phase and homogenized to get the desired particle size of D mean-1.5-2.5 micron. Then previously prepared ethylene diamine solution was added under slow stirring to obtain mixture and the mixture was heated to 1-1.5 hr at 55-60° C. Mixture was then neutralized to pH 5-6 with 1.31 g hydrochloric acid.

Structuring of the mixture was done by adding 2 g xanthan gum (adding 2% gel) and 1.4 g 1,2-Benzisothiazolin-3-One solution to obtain lambda-cyhalothrin CS.

Preparation of Novaluron Mill Base:

Novaluron 50-51% concentrate mill base slurry was prepared by mixing 1.5 g Block copolymer of propylene oxide and ethylene oxide, 3.0 g sodium lignosulfonate, 6.0 g propylene glycol, 0.5 g silicone antifoam, 52.61 novaluron technical in 36.39 g water. The slurry was then milled to the particle size of D₉₀-8-10 micron. This milled slurry was then used for the further mixing in ZC as Novaluron mill base.

Preparation of Lambda-cyhalothrin 20 g/L and Novaluron 100 g/L ZC

516 g water, 50 g clay, 1.4 g 1,2-Benzisothiazolin-3-one solution, 83 g propylene glycol and 193.2 g novaluron (50.5%) mill base was charged in the homogenizing vessel and mixed gently. 5 g silicone antifoam and 88.5 g xanthan gum was added further. Then at low rpm 89.4 g lambda-cyhalothrin CS and 15 g trisiloxane ethoxylate was added. Further, 12.19 g tripotassium phosphate and 2.81 g phosphoric acid was added to obtain storage stable insecticidal composition.

### Example-4 Lambda-cyhalothrin 20 g/L ZC and Novaluron 100 g/L (Comparative Example)

| Ingredients | Quantity (% w/w) |
|---|---|
| Lambda-cyhalothrin CS | 89.4 |
| Novaluron mill base | 193.2 |
| Water | 516 |
| Xanthan gum | 88.5 |
| Propylene Glycol | 83.00 |
| Trisiloxane ethoxylate | 15 |
| Attapulgite clay | 8.5 |
| 1,2-Benzisothiazolin-3-One | 1.4 |
| Silicone antifoam | 5.0 |
| Total | 1000.00 |

Lambda-cyhalothrin CS and Novaluron mill base was prepared as per Example-3 And then to prepare ZC composition, 516 g water, 8.5 g clay, 1.4 g 1,2-Benzisothiazolin-3-one solution, 83 g propylene glycol and 193.2 g novaluron (50.5%) mill base was charged in the homogenizing vessel. 5 g silicone antifoam and 88.5 g xanthan gum was added further. Then at low rpm 89.4 g lambda-cyhalothrin CS and 15 g trisiloxane ethoxylate was added and continued homogenization to obtain an insecticidal composition.

### Example-5 Novaluron 100 g/L+Lambda-cyhalothrin 20 g/L ZC

| | |
|---|---|
| Ingredients | Quantity (% w/w) |

Lambda-cyhalothrin 10-12% CS

| | |
|---|---|
| Lambda-cyhalothrin | 105 |
| Soyabean oil | 200 |
| An oligomeric isocyanate, poly[methylene(phenylene | 1.04 |
| isocyanate)](PMPI) | |
| Hexamethylene diisocyanate (HMDI) | 4.14 |
| Water | 430.1 |
| Sodium lignosulfonate | 50 |
| Silicone antifoam | 1 |
| Ethylene diamine | 1.25 |
| Diethylene triamine | 1.25 |
| Propylene Glycol | 75 |
| Block copolymer surfactant | 25 |
| Hydrochloric acid | 5.2 |
| Xanthan gum 2% solution | 100 |
| 1,2-Benzisothiazolin-3-One Solution | 1 |
| Total | 1000.0 |

Novaluron Mill base

| | |
|---|---|
| Novaluron | 531.25 |
| Sodium lignosulfonate | 30 |
| Block copolymer surfactant | 15 |
| Propylene glycol | 60 |
| Water | 308.8 |
| Silicone antifoam | 0.5 |
| Xanthan gum 2% solution | 50 |
| Total | 1000.0 |

Novaluron 100 g/L + Lambda-cyhalothrin 20 g/L ZC

| Ingredients | Quantity |
|---|---|
| Lambda-cyhalothrin CS | 200 |
| Novaluron mill base | 198 |
| Water | 380.2 |
| Rhodopol 2% gel | 88.5 |
| Propylene Glycol | 83 |
| silwet408 | 15.4 |
| Attagel 50 | 8.5 |
| Proxel gxl | 1.4 |
| SAG 1572 | 5.0 |
| Tri sodium citrate | 14.0 |
| Citric acid | 6.0 |
| Total | 1000.00 |

Preparation of Lambda-cyhalothrin CS: Lambda-cyhalothrin, Soyabean oil, An oligomeric isocyanate, poly[methylene(phenylene isocyanate)](PMPI), Hexamethylene diisocyanate (HMDI), water, sodium lignosulfonate, silicone antifoam, ethylene diamine, diethylene triamine, propylene glycol, Block copolymer surfactant, hydrochloric acid, Xanthan gum 2% solution and 1,2-Benzisothiazolin-3-One Solution were mixed in above quantities and lambda-cyhalothrin CS was prepared according to process given in Example-3.

Preparation of Novaluron Mill Base: Novaluron, sodium lignosulphonate, block copolymer surfactant, propylene glycol, water, silicone antifoam, and xanthan gum 2% solution were mixed in above quantities and novaluron mill base was prepared according to process described in Example-3.

Lambda-cyhalothrin 20 g/L and Novaluron 100 g/L ZC: Lambda-cyhalothrin CS, Novaluron mill base, water, xanthan gum 2% gel, propylene glycol, trisiloxane ethoxylate, attapulgite clay, 1,2-Benzisothiazolin-3-One Solution, silicone antifoam, trisodium citrate and citric acid were mixed in above quantities and ZC composition was prepared according to process given in Example-3.

Physico-chemical Parameters of the composition of Example-5

| | Ambient | AHS, 2 weeks, 54° |
|---|---|---|
| Description | Off white | Off white |
| | color liquid | color liquid |
| | Suspension | Suspension |
| | concentrate | concentrate |
| Novaluron active content | 10.69 | 10.10.47 |
| Imidacloprid content | — | — |
| Lambda-cyhalothrin active content | 2.15 | 2.01 |
| Lambda-cyhalothrin active:inactive | 99.42:0.58 | 99.19:0.81 |
| content (%) | | |
| 1% pH (aq Suspension in DW) | 5.46 | 5.37 |

### Example-6 Lambda-cyhalothrin 20 g/L+Imidacloprid 125 g/L ZC

| | |
|---|---|
| Ingredients | Quantity (% w/w) |

Lambda-cyhalothrin 10-12% Conc CS

| | |
|---|---|
| Lambda-cyhalothrin | 105 |
| Soyabean oil | 200 |
| An oligomeric isocyanate, poly[methylene(phenylene | 1.04 |
| isocyanate)](PMPI) | |
| Hexamethylene diisocyanate (HMDI) | 4.14 |
| Water | 430.1 |
| Sodium lignosulfonate | 50 |
| Silicone antifoam | 1 |
| Ethylene diamine | 1.25 |
| Diethylene triamine | 1.25 |
| Propylene Glycol | 75 |
| Block copolymer surfactant | 25 |
| Hydrochloric acid | 5.2 |
| Xanthan gum 2% solution | 100 |
| 1,2-Benzisothiazolin-3-One Solution | 1 |
| Total | 1000.0 |

Imidacloprid mill base

| | |
|---|---|
| Imidacloprid | 372.6 |
| Ammonium lignosulphonate | 12.0 |
| Polyarylphenyl ethoxylate | 18.0 |
| Precipitated silica | 9 |
| Silicone antifoam | 1.2 |
| Glycerin | 76.0 |
| Water | 511.2 |
| Total | 1000.0 |

Lambda-cyhalothrin 20 g/L + Imidacloprid 125 g/L ZC

| Ingredients | Quantity |
|---|---|
| Imidacloprid mill base | 324.66 |
| Lambda-cyhalothrin CS | 485.00 |
| Citric acid monohydrate | 6.00 |
| Trisodium citrate dihydrate | 14.00 |
| 1,2-Benzisothiazolin-3-One Solution | 1 |
| Xanthan gum 2% Gel | 55 |
| water | 114.34 |
| | 1000.00 |

Preparation of Lambda-cyhalothrin CS: Lambda-cyhalothrin, Soyabean oil, An oligomeric isocyanate, poly[methylene(phenylene isocyanate)](PMPI), Hexamethylene diisocyanate (HMDI), water, sodium lignosulfonate, silicone antifoam, ethylene diamine, diethylene triamine, propylene glycol, Block copolymer surfactant, hydrochloric acid, Xanthan gum 2% solution and 1,2-Benzisothiazolin-3-One Solution were mixed in above quantities and lambda-cyhalothrin CS was prepared according to process given in Example-3.

Preparation of Novaluron Mill Base: Imidacloprid, ammonium lignosulphonate, polyarylphenyl ethoxylate, precipitated silica, silicone antifoam, glycerine and water were mixed in given quantities and mill base was prepared according to the process given in Example-3.

Lambda-cyhalothrin 20 g/L+Imidacloprid 125 g/L ZC: Lambda-cyhalothrin CS, Imidacloprid mill base, citric acid monohydrate, trisodium citrate dihydrate, 1,2-Benzisothiazolin-3-One Solution water, xanthan gum 2% gel and water were mixed in above quantities and ZC composition was prepared according to process given in Example-3.

Physico-chemical Parameters of the composition of Example-6

| | Ambient | AHS, 2 weeks, 54° |
|---|---|---|
| Description | Off white | Off white |
| | color liquid | color liquid |
| | Suspension | Suspension |
| | concentrate | concentrate |
| Novaluron active content | — | — |
| Imidacloprid content | 11.82 | 11.78 |
| Lambda-cyhalothrin active content | 4.82 | 4.78 |
| Lambda-cyhalothrin active:inactive | 98.99:1.01 | 98.49:1.51 |
| content (%) | | |
| 1% pH (aq Suspension in DW) | 5.19 | 5.35 |

Study of the Effect of Mixture of Weak Acid and its Salt in Lambda-cyhalothrin 50 g/L+Imidacloprid 125 g/L SC Composition

Compositions of Example-1 and Example-2 were taken for stability study. Compositions of Example-1 which was prepared by adding mixture of citric acid monohydrate and trisodium citrate dihydrate in the SC composition comprising lambda-cyhalothrin and imidacloprid found to remain stable in all three test conditions viz. ambient, 6-week heat stability at 40° C. and Freeze-thaw 7 cycle. Imidacloprid found to remain stable without much degradation in all three test conditions. The active isomer of lambda-cyhalothrin remained quite stable without much deviation in its active content. Also, the inactive isomer remained quite stable without much deviation in its inactive content Hence, the isomer transformation of Example-1 remained well within acceptable range without much deviation in terms of conversion of active content of lambda-cyhalothrin to its inactive content.

Compositions of Example-2 which was prepared without adding mixture of weak acid and its salt in the SC composition comprising lambda-cyhalothrin and imidacloprid also tested for stability in all three test conditions viz. ambient, 6 week heat stability at 40° C. and Freeze-thaw 7 cycle conditions. Imidacloprid found to remain stable without much degradation in all three test conditions. The active isomer content of lambda-cyhalothrin remained quite stable without much deviation in its active content. But inactive isomer content of lambda-cyhalothrin increased from 1.02% to 7.27% in ambient, 3.45% to 47.5% in heat stability testing when kept for 6 weeks at 40° C. and 0.84% to 8.2% in Freeze thaw study. This shows, in the absence of mixture of weak acid and its salt, isomer transformation from active isomer to inactive isomer occurred rapidly, thus deteriorating the insecticidal composition of Example-2. (Table-1)

TABLE 1

| | Example-1 | | | Example-2 | | |
|---|---|---|---|---|---|---|
| | | Heat | | | Heat | |
| | | stability 6 | Freeze- | | stability 6 | |
| | | week at | thaw 7 | | week at | Freeze- |
| | Ambient | 40° C. | cycle | Ambient | 40° C. | thaw 7 cycle |
| Description | Off white | Off white | Off white | Off white | Off white | Off white |
| | color | color liquid | color | color | color | color liquid |
| | liquid | Suspension | liquid | liquid | liquid | Suspension |
| | Suspension | concentrate | Suspension | Suspension | Suspension | concentrate |
| | concentrate | | concentrate | concentrate | concentrate | |
| Imidacloprid | 11.62 | 11.60 | 11.58 | 12.12 | 12.02 | 12.10 |
| active | | | | | | |
| content | | | | | | |
| Lambda- | 4.769 | 4.764 | 4.694 | 4.625 | 2.62 | 4.58 |
| cyhalothrin | | | | | | |
| active | | | | | | |
| content | | | | | | |
| Lambda- | 98.98:1.02 | 96.55:3.45 | 99.16:0.84 | 92.73:7.27 | 52.5:47.5 | 91.8:8.2 |
| cyhalothrin | | | | | | |
| active:inactive | | | | | | |
| content (%) | | | | | | |
| 1% pH (aq | 6.04 | 6.03 | 6.06 | 7.16 | 7.10 | 7.18 |
| Suspension | | | | | | |
| in DW) | | | | | | |

Study of the Effect of Mixture of Weak Acid and its Salt in Lambda-cyhalothrin 20 g/L and Novaluron 100 g/L ZC Composition

Compositions of Example-3 and Example-4 were taken for stability study. Compositions of Example-3 which was prepared by adding mixture of phosphoric acid and potassium dihydrogen phosphate in the ZC composition comprising lambda-cyhalothrin and novaluron found to remain stable in ambient as well as in Accelerated Heat Stability (AHS) test for 2 weeks at 54° C. Imidacloprid found to remain stable without much degradation in all three test conditions. The active isomer of lambda-cyhalothrin remained quite stable without much deviation in its active content. Also, the inactive isomer remained quite stable without much deviation in its inactive content Hence, the isomer transformation of Example-3 remained well within acceptable range without much deviation in terms of conversion of active content of lambda-cyhalothrin to its inactive content Compositions of Example-4 which was prepared without adding mixture of weak acid and its salt (e.g. mixture of phosphoric acid and potassium hydrogen phosphate as in Example-3) in the ZC composition comprising lambda-cyhalothrin and novaluron also tested for stability in in ambient as well as in AHS test for 2 weeks at 54° C. Imidacloprid found to remain stable without much degradation in all three test conditions. The active isomer content of lambda-cyhalothrin remained quite stable without much deviation in its active content But inactive isomer content of lambda-cyhalothrin increased from 4.35% to 17.16% in ambient, 8.44% to 45.65% in heat stability testing when kept for 6 weeks at 40° C. This shows, in the absence of mixture of weak acid and its salt, isomer transformation from active isomer to inactive isomer occurred rapidly, thus deteriorating the insecticidal composition of Example-4. (Table 2)

TABLE 2

| | Example-3 | | Example-4 | |
|---|---|---|---|---|
| | | Heat | | Heat |
| | | stability 2 | | stability 2 |
| | Ambient | week at 54° | Ambient | week at 54° |
| Description | Off white | Off white | Off white | Off white |
| | color liquid | color liquid | color liquid | color liquid |
| | Suspension | Suspension | Suspension | Suspension |
| | concentrate | concentrate | concentrate | concentrate |
| Novaluron | 10.33 | 10.28 | 10.56 | 10.54 |
| active content | | | | |
| Lambda- | 2.031 | 2.022 | 1.905 | 1.277 |
| cyhalothrin | | | | |
| active content | | | | |
| Lambda- | 95.65:4.35 | 91.56:8.44 | 82.84:17.16 | 54.35:45.65 |
| cyhalothrin | | | | |
| active:inactive | | | | |
| content (%) | | | | |
| 1% pH (aq | 5.80 | 5.74 | 6.38 | 6.35 |
| Suspension | | | | |
| in DW) | | | | |

### Example-7 Lambda-cyhalothrin 10% CS

| Ingredients | Quantity (% w/w) |
|---|---|
| Lambda-cyhalothrin | 105 |
| Vegetable oil | 200 |
| An oligomeric isocyanate, poly[methylene(phenylene | 1.04 |
| isocyanate)](PMPI) | |
| Hexamethylene diisocyanate (HMDI) | 4.14 |
| Water | 430.1 |
| Anionic surfactant | 50 |
| Antifoam | 1 |
| Ethylene diamine | 1.25 |
| Diethylene triamine | 1.25 |
| Propylene Glycol | 75 |
| Nonionic surfactant | 25 |
| Hydrochloric acid | 5.2 |
| Xanthan gum 2% solution | 100 |
| Biocide | 1 |
| Total | 1000.0 |

Process:—

Preparation of organic phase: 105 g Lambda-cyhalothrin technical, 200 g vegetable oil, 1.04 g PMPI and 4.15 g HMDI was mixed and homogenized to obtain organic phase.

Preparation of aqueous phase: 50 g anionic surfactant, 75 g propylene glycol, 25 g non-ionic surfactant, 1 g antifoam and 400.1 g water were mixed and homogenized to obtain aqueous phase.

Preparation of amine solution: 1.25 g ethylene diamine and diethylene triamine 1.25 g was dissolved in 30 gm water to obtain solution.

Previously prepared organic phase was added to previously prepared aqueous phase and homogenized to get the desired particle size of D mean-1.5-2.5 micron. Then previously prepared amine solution was added under slow stirring to obtain mixture and the mixture was heated to 1-1.5 hr at 55-60° C. Mixture was then neutralized to pH 5-6 with 5.2 g hydrochloric acid. Structuring of the mixture was done by adding 100 g xanthan gum (adding 2% gel) and 0.1 g biocide solution to obtain lambda-cyhalothrin CS.

### Example-8 Lambda-cyhalothrin 23.5% Conc CS Using Aromatic Hydrocarbon

| Ingredients | Quantity (% w/w) |
|---|---|
| Lambda-cyhalothrin | 24.74 |
| Solvent | 15.00 |
| Hexamethylene diisocynate | 0.47 |
| An oligomeric isocyanate, poly[methylene(phenylene | 0.025 |
| isocyanate)](PMPI) | |
| Anionic surfactant | 5.00 |
| Antifoam | 0.10 |
| Glycerin | 7.00 |
| Non-ionic surfactant | 2.50 |
| Hydrochloride acid (35% solution) | 0.52 |
| Xanthan gum 2% solution | 0.06 |
| biocide | 0.10 |
| Ethylene diamine | 0.165 |
| Diethylene triamine | 0.165 |
| Water | qs |
| Total | 100.0 |

Lambda-cyhalothrin, solvent, hexamethylene diisocyanate, poly[methylene(phenylene isocyanate)] (PMPI), anionic surfactant, antifoam, glycerin, non-ionic surfactant, hydrochloride acid (35% solution), xanthan gum 2% solution, biocide, ethylene diamine, diethylene triamine and water were mixed in above mentioned quantity and CS was prepared as per the process disclosed in Example-7.

### Example-9 Chlorantraniliprole 50% w/w Mill Base

| Ingredients | Quantity (% w/w) |
|---|---|
| Chlorantraniliprole | 526.31 |
| Anionic surfactant | 60 |
| Water | 408.69 |
| Antifoam | 5.00 |
| Total | 1000.0 |

A mill base was prepared the by mixing chlorantraniliprole, anionic surfactant, antifoam and water in the bead mill to obtain desired particle size. The same mill base was used in processing various finished formulations developed according to the present invention.

### Example 10: Lambda-cyhalothrin 66.67 g/L and Chlorantraniliprole 80 g/L ZC

| Ingredients | Quantity |
|---|---|
| Chlorantraniliprole 50% mill base of Example-9 | 154.0 |
| Lambda-cyhalothrin CS of Example-2 | 265.8 |
| Water | 460.2 |
| Xanthan gum (2% gel) | 99 |
| Biocide | 1.0 |
| Trisodium citrate | 14.0 |
| Citric acid | 6.0 |
| Total | 1000.00 |

Process: —Chlorantraniliprole 50% mill base of example-9, water, trisodium citrate, citric acid, and xanthan gum were mixed together to obtain homogeneous mixture. Then lambda-cyhalothrin CS of Example-8 was added to the mixture to obtain CS formulation.

Stability Study of Lambda-cyhalothrin 66.67 g/L and Chlorantraniliprole 80 g/L ZC

The Lambda-cyhalothrin 66.67 g/L and Chlorantraniliprole 80 g/L ZC composition developed in Example-10 was taken for stability testing in various conditions such as ambient, AHS for 2 weeks at 54° C. and freeze thaw. The compositions retained its acceptable physical appearance during all the three testing conditions. The chlorantraniliprole active content remained stable without any noticeable degradation. Similarly, lambda-cyhalothrin active content remained stable without any noticeable degradation. In all the three testing conditions, the isomer transformation did not occur. The active isomer content remained above 99% in ambient, AHS as well as FT studies. pH of the composition remained in acceptable range. (Table 3)

TABLE 3

| | | AHS (2 weeks | Freeze-thaw (FT) |
|---|---|---|---|
| | Ambient | at 54° C.) | 7 cycle |
| Description | Off white | Off white | Off white |
| | color liquid | color liquid | color liquid |
| | Suspension | Suspension | Suspension |
| | concentrate | concentrate | concentrate |
| Chlorantraniliprole | 7.96 | 7.92 | 7.96 |
| active content | | | |
| Lambda- | 6.431 | 6.63 | 6.40 |
| cyhalothrin active | | | |
| content | | | |
| Lambda- | 99.30:0.70 | 99.05:0.95 | 99.16:0.84 |
| cyhalothrin | | | |
| active:inactive | | | |
| content (%) | | | |
| 1% pH (aq | 5.01 | 4.96 | 4.99 |
| Suspension in DW) | | | |

### Example-11: Flonicamid 44% w/w Mill Base

| Ingredients | Quantity (% w/w) |
|---|---|
| Flonicamid | 682.8 |
| Solvent | 75 |
| Non-ionic surfactant | 75 |
| Antifoam | 7.5 |
| Biocide | 1.5 |
| Xanthan gum (2% gel) | 105 |
| Water | QS |
| Total | 1500 |

A mill base was prepared the by mixing flonicamid, solvent, non-ionic surfactant, antifoam, biocide, xanthan gum and water in the bead mill to obtain desired particle size. The same mill base was used in processing various finished formulations developed according to the present invention.

### Example 12A and 12B: Lambda-cyhalothrin 40 g/L and Flonicamid 160 g/L ZC

| Ingredients | Example 12A | Example 12B |
|---|---|---|
| Flonicamid mill base of Example-11 | 343.89 | 343.89 |
| Lambda-cyhalothrin CS of Example-7 | 400 | 0.00 |
| Lambda-cyhalothrin CS of Example-8 | 0.00 | 170.21 |
| Water | 196.11 | 385.9 |
| Xanthan gum (2% gel) | 39.8 | 79.4 |
| Biocide | 0.2 | 0.4 |
| Trisodium citrate | 14.0 | 14.0 |
| Citric acid | 6.0 | 6.0 |
| Total | 1000.00 | 1000.00 |

Two compositions (12A and 12B) of Lambda-cyhalothrin 40 g/L and Flonicamid 160 g/L ZC were developed by mixing Flonicamid mill base of Example-11, trisodium citrate, citric acid, xanthan gum (2% gel) and water were mixed together to obtain homogeneous mixture. Then, in one composition Lambda-cyhalothrin CS of Example-7 was added and in other Lambda-cyhalothrin CS of Example-8 was added to obtain two ZC preparations.

Stability Study of Lambda-cyhalothrin 40 g/L and Flonicamid 160 g/L ZC Obtained in 12A and 12B

The two different compositions of Lambda-cyhalothrin 66.67 g/L and Chlorantraniliprole 80 g/L ZC composition developed in Example-12A and Example-12B were taken for stability testing in various conditions such as ambient, AHS for 2 weeks at 54° C. and freeze thaw. The compositions retained its acceptable physical appearance during all the three testing conditions. The cflonicamid active content remained stable without any noticeable degradation. Similarly, lambda-cyhalothrin active content remained stable without any noticeable degradation. In all the three testing conditions, the isomer transformation did not occur. The active isomer content remained above 97% in ambient, AHS as well as FT studies. pH of the composition remained in acceptable range. (Table 4)

TABLE 4

| | Example-12A | | | Example-12B | | |
|---|---|---|---|---|---|---|
| | | AHS | Freeze-thaw | | AHS | Freeze-thaw |
| | | (2 weeks, | (FT) 7 | | (2 weeks, | (FT) 7 |
| | Ambient | 54° C.) | cycle | Ambient | 54° C.) | cycle |
| Description | Off white | Off white | Off white | Off white | Off white | Off white |
| | color | color | color | color | color | color |
| | liquid | liquid | liquid | liquid | liquid | liquid |
| | Suspension | Suspension | Suspension | Suspension | Suspension | Suspension |
| | concentrate | concentrate | concentrate | concentrate | concentrate | concentrate |
| Flonicamid | 15.73 | 15.69 | 15.71 | 15.91 | 15.72 | 15.84 |
| active | | | | | | |
| content | | | | | | |
| Lambda- | 4.27 | 4.24 | 4.24 | 4.30 | 4.13 | 4.254 |
| cyhalothrin | | | | | | |
| active | | | | | | |
| content | | | | | | |
| Lambda- | 99.16:0.83 | 98.24:1.76 | 99.0:0.98 | 98.8:1.19 | 97.36.02:2.64 | 98.66:1.34 |
| cyhalothrin | | | | | | |
| active:inactive | | | | | | |
| content (%) | | | | | | |
| 1% pH (aq | 5.11 | 5.09 | 5.13 | 5.14 | 5.05 | 5.11 |
| Suspension | | | | | | |
| in DW) | | | | | | |

### Example 13: Imidacloprid 43% w/w Mill Base

| Ingredients | Quantity (% w/w) |
|---|---|
| Imidacloprid technical | 1265.42 |
| Anionic surfactant | 28.64 |
| Polyarylphenyl ethoxylate | 42.96 |
| Silica | 21.48 |
| Antifoam | 2.864 |
| Glycerin | 186.16 |
| Biocide | 2.864 |
| water | 1313.612 |
| total | 2864 |

A mill base was prepared the by mixing imidacloprid, anionic surfactant, polyarylphenyl ethoxylate, silica, antifoam, glycerin, biocide and water in the bead mill to obtain desired particle size. The same mill base was used in processing various finished formulations developed according to the present invention.

### Example 14: Lambda-cyhalothrin 100 g/L and Imidacloprid 200 g/L ZC

| Ingredients | Example 6A |
|---|---|
| Imidacloprid mill base of Example-13 | 418.0 |
| Lambda-cyhalothrin CS of Example-8 | 383.0 |
| Water | 134 |
| Xanthan gum (2% gel) | 44.75 |
| Biocide | 0.25 |
| Trisodium citrate | 14.0 |
| Citric acid | 6.0 |
| Total | 1000.00 |

Imidacloprid mill base of Example-11, xanthan gum, biocide, citric acid, trisodium citrate and water were mixed together to obtain homogeneous mixture. Lambda-cyhalothrin CS of Example-8 was added to the homogeneous mixture to obtain ZC formulation.

Stability study of Lambda-cyhalothrin 100 g/L and Imidacloprid 200 g/L ZC

The Lambda-cyhalothrin 100 g/L and Imidacloprid 200 g/L ZC composition developed in Example-14 was taken for stability testing in various conditions such as ambient, AHS for 2 weeks at 54° C. and freeze thaw. The compositions retained its acceptable physical appearance during all the three testing conditions. The Imidacloprid active content remained stable without any noticeable degradation. Similarly, lambda-cyhalothrin active content remained stable without any noticeable degradation. In all the three testing conditions, the isomer transformation did not occur. The active isomer content remained above 98% in ambient, AHS as well as FT studies. pH of the composition remained in acceptable range. (Table 5)

TABLE 5

| | | Heat stability 2 | Freeze-thaw 7 |
|---|---|---|---|
| | Ambient | week at 54° C. | cycle |
| Description | Off white | Off white | Off white |
| | color liquid | color liquid | color liquid |
| | Suspension | Suspension | Suspension |
| | concentrate | concentrate | concentrate |
| Imidacloprid active | 19.38 | 19.32 | 19.34 |
| content | | | |
| Lambda-cyhalothrin | 9.56 | 9.54 | 9.55 |
| active content | | | |
| Lambda-cyhalothrin | 98.94:1.06 | 98.90:1.1 | 98.93:1.07 |
| active:inactive | | | |
| content (%) | | | |
| 1% pH (aq | 5.41 | 5.29 | 5.32 |
| Suspension in DW) | | | |

### Example 15: Lambda-cyhalothrin 40 g/L and Spirotetramat 40 g/L ZC

Step 1: Spirotetramat 40% w/w SC.

| Ingredient | Quantity |
|---|---|
| Spirotetramat technical | 40.81 |
| Propylene glycol | 5.00 |
| Non-ionic surfactant | 2.00 |
| Anionic surfactant | 1.50 |
| Antifoam | 0.50 |
| Biocide | 0.10 |
| Thickener | 5.00 |
| Water | 45.08 |
| Total | 100.0 |

A suspension concentrate as a mill base was prepared by mixing spirotetramat, propylene glycol, non-ionic surfactant, anionic surfactant, antifoam, water, biocide and thickener in the above mentioned quantity in bead mill to attain desired particle size and kept for further processing.

Step 2: ZC Preparation:

| Ingredient | Quantity |
|---|---|
| Lambda-cyhalothrin CS of Example-7 | 40.00 |
| Spirotetramat SC of step-1 | 10.00 |
| Paraffin Oil | 30.00 |
| Non-ionic surfactant | 2.00 |
| Anionic surfactant | 2.00 |
| Biocide | 0.10 |
| Antifoam | 0.50 |
| Propylene glycol | 4.50 |
| Thickener | 5.00 |
| Citric Acid | 0.60 |
| Trisodium citrate | 1.40 |
| Water | 3.90 |
| Total | 100.00 |

Process: —Take the Spirotetramat 40% mill base prepared in step-1 and add water, non-ionic and anionic surfactant, propylene glycol, trisodium citrate, citric acid, biocide and mixed for homogeneity. Then paraffin oil was added and homogenized and further 2% Rhodopol gel was added and again homogenized for uniformity. Then Lambda-cyhalothrin CS prepared as per example 7 was added and mixed for homogeneity. The samples were tested for heat stability for 2 week at 54° C. and Freeze-thaw 7 cycle the results tabulated as below. (Table 6)

TABLE 6

| | Example-10 | | |
|---|---|---|---|
| | | Heat stability 2 | Freeze-thaw 7 |
| Parameters | Ambient | week at 54° C. | cycle |
| Description | Off white | Off white | Off white |
| | color liquid | color liquid | color liquid |
| | Suspension | Suspension | Suspension |
| | concentrate | concentrate | concentrate |
| Spirotetramat active | 4.57 | 4.38 | 4.58 |
| content | | | |
| Lambda-cyhalothrin | 4.23 | 4.23 | 4.23 |
| active content | | | |
| Lambda-cyhalothrin | 99.02:0.98 | 98.96:1.04 | 99.13:0.87 |
| active:inactive | | | |
| content (%) | | | |
| 1% pH (aq Suspension | 5.34 | 5.33 | 5.35 |
| in DW) | | | |

Inventors of the present invention thus successfully prepared storage stable insecticidal compositions of lambda-cyhalothrin in combination with other agrochemically active ingredients. In the presence of mixture of weak acid and its salt, lambda-cyhalothrin isomer transformation from active form to inactive form remain under control when a composition of lambda-cyhalothrin is prepared along with another active ingredient. The invention demonstrates effective composition with good shelf life.

1. An insecticidal composition comprising:
a. lambda cyhalothrin in an amount of 0.1% to 50% by weight of the composition;
b. at least one other insecticide in an amount of 0.1% to 50% by weight of the composition; and
c. a mixture of a weak acid and its salt.

2. The composition as claimed in claim 1, wherein the at least one other insecticide is selected from the group consisting of neonicotinoids, benzoylphenyl ureas, diamide insecticides, tetramic acid, flonicamid, and combinations thereof.

3. The composition as claimed in claim 2, wherein said neonicotinoid insecticide is selected from the group consisting of clothianidin, imidacloprid, acetamiprid, thiamethoxam, thiacloprid, and combinations thereof.

4. The composition as claimed in claim 2, wherein said benzoylphenyl urea insecticide is selected from the group consisting of bistrifluron, chlorbenzuron, chlorfluazuron, dichlorbenzuron, diflubenzuron, flucycloxuron, flufenoxuron, hexaflumuron, lufenuron, novaluron, noviflumuron, penfluron, teflubenzuron, triflumuron and combinations thereof.

5. The composition as claimed in claim 2, wherein said tetramic acid insecticide is spirotetramat.

6. The composition as claimed in claim 2, wherein said diamide insecticide is selected from the group consisting of chlorantraniliprole, cyantraniliprole, cyclaniliprole, tetrachlorantraniliprole and tetraniliprole.

7. The composition as claimed in claim 2, wherein the at least one other insecticide is imidacloprid, novaluron, spirotetramat, flonicamid, or chlorantraniliprole.

8. The composition as claimed in claim 1, wherein said mixture of a weak acid and its salt is a mixture of an organic acid and its salt, said organic acid being selected from the group consisting of citric acid, acetic acid, succinic acid, glutaric acid, maleic acid, tartaric acid, and oxalic acid.

9. The composition as claimed in claim 8, wherein the weak acid is citric acid and the salt selected from the group consisting of sodium citrate, sodium citrate monobasic, sodium citrate dibasic, potassium citrate; the acid is acetic acid and the salt is selected from the group consisting of sodium acetate, and ammonium acetate; the acid is succinic acid and the salt is selected from the groups consisting of sodium succinate mono and dibasic; or the salt is tartaric acid and the salt is selected from the group consisting of sodium tartarate monobasic and sodium tartarate dibasic.

10. The composition as claimed in claim 1, wherein the mixture of weak acid and its salt is a mixture of an inorganic acid and its salt, said inorganic acid being selected from the group consisting of phosphoric acid, boric acid, and salts thereof.

11. The composition as claimed in claim 10, wherein the weak acid is phosphoric acid and the salt is selected from the group consisting of sodium phosphate dibasic, sodium phosphate monobasic, potassium metaphosphate, potassium phosphate dibasic, potassium phosphate monobasic, ammonium phosphate, and diluted potassium metaphosphate.

12. An insecticidal composition comprising:
a. lambda cyhalothrin in an amount of 0.1% to 50% by weight of the composition;
b. at least one insecticide selected from the group consisting of neonicotinoids, benzoylphenyl ureas, tetramic acid, diamide insecticides and flonicamid in an amount of 0.1% to 50% by weight of the composition; and
c. a mixture of a weak acid and its salt.

13. The insecticidal composition as claimed in claim 12
wherein said neonicotinoid insecticide is imidacloprid.

14. The insecticidal composition as claimed in claim 12, wherein said benzoylphenyl urea insecticide is novaluron.

15. The insecticidal composition as claimed in claim 12,
wherein said tetramic acid insecticide is spirotetramat

16. The insecticidal composition as claimed in claim 12,
wherein said diamide insecticide is chlorantraniliprole.

17. The insecticidal composition as claimed in claim 12,
wherein b) is Flonicamid.

18. The composition as claimed in claim 12 wherein said mixture of the weak acid and its salt is selected from the group consisting of:
a mixture of citric acid monohydrate and trisodium citrate dihydrate; and
a mixture of phosphoric acid and potassium hydrogen phosphate.

19. The composition as claimed in claim 1, wherein said composition is a liquid composition.

20. The composition as claimed in claim 19, wherein said composition is a suspension concentrate (SC), a capsular suspension (CS), or a mixture of both (ZC).

21. A process for the preparation of the composition of claim 1, comprising
a. mixing the lambda-cyhalothrin with the at least one other insecticide,
b. optionally, adding other excipients(s) to obtain a pre-mix, and
c. adding the mixture of the weak acid and its salt to the pre-mix to obtain the insecticidal composition.

22. A process for the preparation of the composition of claim 1, comprising:
a. mixing the lambda-cyhalothrin and the at least one other insecticide in an aqueous condition and adding other excipients(s) to obtain a pre-mix;
b. milling the resulting pre-mix; and
c. adding a thickener and the mixture of the weak acid and its salts to the pre-mix followed by homogenization to obtain the composition in the form of a suspension concentrate.

23. A process for the preparation of the composition of claim 1, comprising
a. mixing the lambda-cyhalothrin and the at least one other insecticide in an aqueous condition and optionally, adding other excipients(s) to obtain a premix,
b. milling the resulting pre-mix;
c. adding the mixture of the weak acid and its salts to the pre-mix; and
d. gellifying the mixture of c) by adding a separately prepared thickener composition to obtain the composition in the form of suspension concentrate.

24. A process for the preparation of the composition of claim 1,
i. preparing a capsule suspension of the lambda-cyhalothrin;
ii. preparing a suspension concentrate of the at least one other insecticide;
iii. separately dissolving an amine salt in water to obtain an amine solution; and
iv. mixing the suspension concentrate of step (ii), the mixture of a weak acid and its salt, the amine solution and the capsule suspension of lambda-cyhalothrin to obtain a ZC composition.

25. A process for the preparation of the composition of claim 1,
i. preparing an organic phase comprising the lambda-cyhalothrin solubilized in vegetable oil or derivatives thereof, and at least one isocyanate;
ii. preparing an aqueous phase by mixing auxiliary ingredients in water;
iii. separately dissolving an amine salt in water to obtain an amine solution;
iv. mixing the organic phase of step (i), the aqueous phase of step (ii) and the amine solution of step (iii) to obtain an encapsulated lambda-cyhalothrin as a capsule suspension;
v. separately preparing a suspension concentrate of the at least one other insecticide;
vi. mixing the capsule suspension of step (iv) with the suspension concentrate of step (v); and
vii. adding the mixture of the weak acid and its salt to obtain the composition in the form of a ZC formulation.

26. The process as claimed in claim 25, wherein the composition has a particle size distribution D₁₀ of less than about 10 microns, or a D₅₀ of less than about 10.0 microns, or a D₉₀ of less than or equal to about 20 microns.

27. A method for controlling pests which comprises applying and effective amounts of the composition of claim 1 to pests or to a locus where the pests inhabit.

28. The method as claimed in claim 27, wherein the at least one other insecticide is imidacloprid, novaluron, spirotetramat, flonicamid, or chlorantraniliprole.

29. The method as claimed in claim 27, wherein the mixture of the weak acid and its salt is a mixture of citric acid monohydrate and trisodium citrate dihydrate.

30. The method as claimed in claim 27, wherein the mixture of the weak acid and its salt is a mixture of phosphoric acid and potassium hydrogen phosphate.

31. A kit comprising:
a. a first component comprising lambda cyhalothrin;
b. a second component comprising at least one other insecticide; and
c. a third component comprising a mixture of a weak acid and its salt,
wherein the first, second and third components are instructed to be admixed before being applied to a locus.
